(19) United States
(12) Patent Application Publication
(10) Pub. No.: US 2020/0184451 A1
(43) Pub. Date: Jun. 11, 2020

(54) SYSTEMS AND METHODS FOR ACCOUNT EVENT NOTIFICATION

(71) Applicant: Mastercard International Incorporated, Purchase, NY (US)

(72) Inventors: Michelle L. Hafner, Chesterfield, MO (US); David J. Senci, Troy, IL (US); Jill Boyd Bugh, Town and Country, MO (US)

(73) Assignee: Mastercard International Incorporated, Purchase, NY (US)

(21) Appl. No.: 16/210,233

(22) Filed: Dec. 5, 2018

(51) Int. Cl. G06Q 20/32; G06Q 20/34

(52) U.S. Cl. CPC G06Q 20/322; G06Q 20/34

(57) ABSTRACT

A system and computer-implemented method includes the operations of receiving an electronic transaction message including transaction data from an interchange network. The transaction message may include a type of transaction associated with a primary account number of the cardholder. A type of transaction may be determined from the electronic transaction message. Transaction details may be extracted from the transaction data. The operations may also include determining whether the cardholder is registered for the account event notification service. If based on the determination, the cardholder is registered for the account event notification service, a notification message may be generated. The notification message may include the type of transaction. The notification message may be transmitted to the cardholder.

### FIELD OF THE DISCLOSURE

The field of the disclosure relates generally to electronic financial transactions and, more particularly, to systems and methods for notifying a consumer of certain selected account events.

### BACKGROUND OF THE DISCLOSURE

A typical consumer performs payment card transactions in several ways with varying purchase amounts and number of transactions in a given period. On occasion, the consumer may receive a reversal or credit on his or her account, request a chargeback to the merchant, and/or be declined because of suspected fraud. Within the payment card processing system, the consumer typically does not receive notification of such account events until a transaction has cleared and the event is presented to the consumer on the billing statement.

At least some known large merchants or payment card issuers provide a limited service for transmitting notifications or messages to the consumer when there is suspected fraud or when a reversal is being processed with the payment card. However, such notifications or message services are inconsistent across merchants and issuers and are not scalable for consumers who shop at multiple locations and/or use several payment cards from different payment card issuers. As such, when a consumer executing a transaction is falsely declined or when the consumer receives a refund or credit to his or her account, the consumer may have no idea that it has occurred until days or weeks later, after receiving a billing statement.

### BRIEF DESCRIPTION OF THE DISCLOSURE

This summary is not intended to identify essential features of the present disclosure and is not intended to be used to limit the scope of the claims. These and other aspects of the present disclosure are described below in greater detail.

In one aspect, a computer-implemented method for notifying a cardholder of an account event is provided. Using an account event notification service, the method includes receiving an electronic transaction message including transaction data from an interchange network. The transaction message includes a type of transaction associated with a primary account number of the cardholder. In addition, the method includes determining the type of transaction from the electronic transaction message and extracting transaction details from the transaction data. Furthermore, the method includes determining whether the cardholder is registered for the account event notification service. The method also includes generating a notification message if, based on the determination, the cardholder is registered for the account event notification service. The notification message includes the type of transaction. Moreover, the method includes transmitting the notification message to the cardholder.

In another aspect, a system for notifying a cardholder of an account event is provided. The system includes a cardholder account information database, a transaction database, and an account event notification service server. The account event notification service server includes a processor programmed to receive an electronic transaction message including transaction data from the transaction database. The transaction message includes a type of transaction associated with a primary account number of the cardholder. The processor is also programmed to determine the type of transaction from the electronic transaction message and to extract transaction details from the transaction data. Furthermore, the processor is programmed to determine whether the cardholder has an account event notification service account stored on the cardholder account information database. Moreover, the processor is programmed to generate a notification message if, based on the determination, the cardholder has an account event notification service account. The notification message includes the type of transaction. In addition, the processor is programmed to transmit the notification message to the cardholder.

### BRIEF DESCRIPTION OF THE DRAWINGS

Embodiments of the present disclosure are described in detail below with reference to the attached drawing figures, wherein:

FIG. 1 is a block diagram of an account event notification service system including an account event notification service server, in accordance with one embodiment of the present disclosure;

FIG. 2 is a simplified block diagram of an exemplary payment card network system including the account event notification service server shown in FIG. 1;

FIG. 3 is an example configuration of a user system for use with the payment card network system shown in FIG. 2;

FIG. 4 is an example configuration of a server system for use in the payment card network system shown in FIG. 2;

FIG. 5 is a flowchart illustrating an exemplary computer-implemented method for registering a cardholder for an account event notification service using the account event notification service server shown in FIG. 1; and

FIG. 6 is a flowchart illustrating a computer-implemented method for generating an account event notification using an account event notification service using the account event notification service server shown in FIG. 1.

The figures are not intended to limit the present disclosure to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. It is contemplated that the disclosure has general application to identifying and verifying entities requesting access to confidential information and/or financial services. The scope of the present disclosure is defined only by the appended claims, along with the full scope of equivalents to which such claims are entitled.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present disclosure can include a variety of combinations and/or integrations of the embodiments described herein.

Broadly characterized, the present disclosure relates to systems and methods to facilitate providing notifications to cardholders for selected account transaction types, such as, a credit transaction, a reversal transaction, a chargeback transaction, and/or a message declining a transaction due to suspected fraud. A cardholder opts-in to a payment network account event notification service where the cardholder provides data relating to his or her payment accounts for which he or she would like to receive notifications, and account event notification data (i.e., selected transaction events for which he or she would like to receive notifications). The payment network analyzes each transaction of the participating cardholder and provides a notification to the cardholder for each selected type of transaction event. More particularly, the cardholder leverages a mobile application to register for the account event notification service and enter selected transaction event prompts. The cardholder enrollment process is secure and authenticates the cardholder. The payment network stores the cardholder's account details and compares transactions against the cardholder's registered accounts to the select transaction event prompts. When a transaction type matches a selected transaction event prompt, the account event notification service transmits a notification of the transaction event to the cardholder.

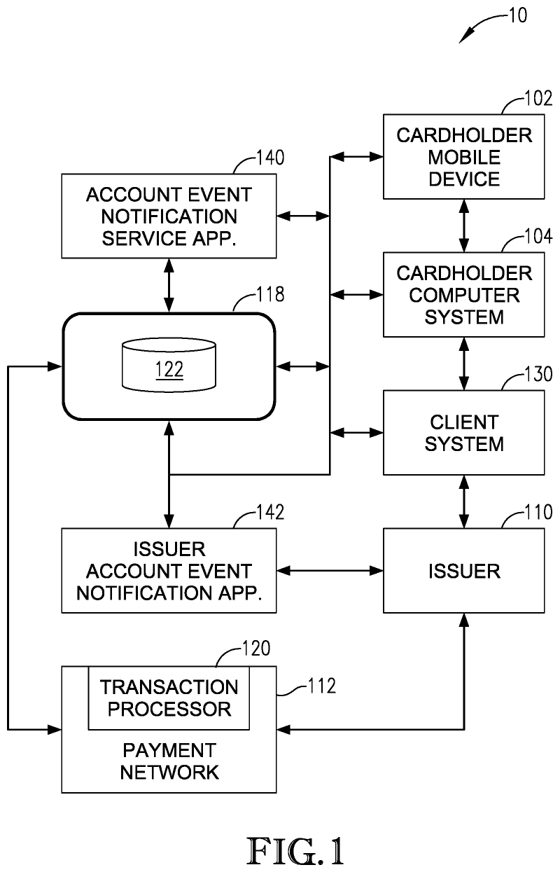

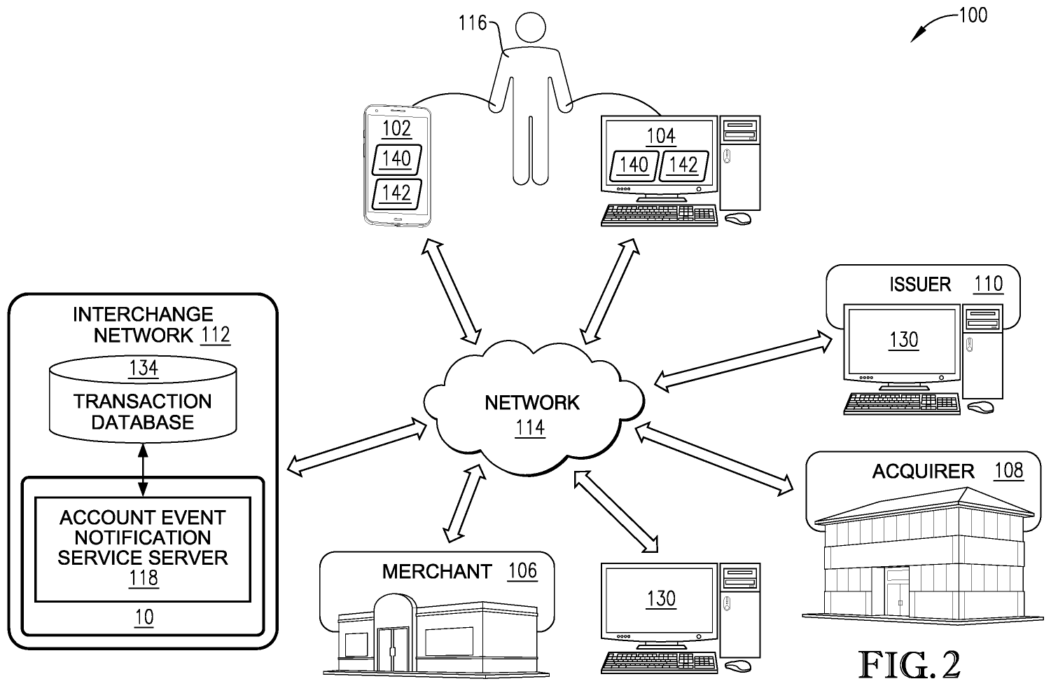

FIG. 1 is a block diagram of an account event notification service system 10 including an account event notification service (AENS) server 118. The AENS server 118 includes at least one processor (not shown) in communication with a cardholder account information database 122. The cardholder account information database 122 contains information on a variety of matters, including, for example, primary account numbers (PANs) associated with an account event notification service for one or more users, stored account event notification data for one or more users, one or more user profiles, and other information described herein. In one embodiment, the cardholder account information database 122 is stored on the AENS server 118. In an alternative embodiment, the cardholder account information database 122 is stored remotely from the AENS server 118 and may be non-centralized. In the example embodiment, the account event notification service system 10 is in communication with a transaction processor 120, which is integral to and/or associated with a payment or interchange network 112. The interchange network 112 is described more fully herein with respect to FIG. 2.

In the example embodiment, the account event notification service system 10 further includes a plurality of client systems or subsystems 130 (associated, for example, with an issuer 110), cardholder mobile devices 102, and/or cardholder computer systems 104. In one embodiment, the cardholder mobile devices 102 and cardholder computer systems 104 are computers including a web browser or application, such that the AENS server 118 is accessible to the cardholder mobile devices 102 and the cardholder computer systems 104 using the Internet. The cardholder mobile devices 102 and the cardholder computer systems 104 are interconnected to the Internet through many interfaces including a network, such as a local area network (LAN) and/or a wide area network (WAN), dial-in connections, cable modems, wireless-connections, and special high-speed ISDN lines. The cardholder mobile devices 102 and the cardholder computer systems 104 may be any device capable of interconnecting to the Internet including mobile computing devices, such as a laptop or desktop computer, a web-based phone (e.g., a “smart phone”), a personal digital assistant (PDA), a tablet or phablet, a web-connectable appliance, a “smart watch” or other wearable device, or other web-connectable equipment. It should be understood that the account event notification service system 10 may include any number of cardholder computer systems 104 and cardholder mobile devices 102.

The AENS server 118 is configured to communicate with at least the cardholder mobile device 102 and/or the cardholder computer system 104 associated with a cardholder 116 (shown in FIG. 2). The cardholder mobile device 102 and/or cardholder computer system 104 is configured to execute for presentation an account event notification service (AENS) application 140. In some embodiments, the AENS application 140 may be stored in a cloud-based interface, which may include cloud storage capability as well as any cloud-based API that facilitates communication between the cardholder mobile device 102 and/or the cardholder computer system 104 and the AENS server 118. The AENS application 140 stores a user profile associated with the user, for example, in the cardholder account information database 122. The user profile includes cardholder contact and payment account data for the cardholder 116. Additionally, the user profile may be viewed, accessed, and/or updated by the cardholder mobile device 102 and/or the cardholder computer system 104. The cardholder 116 accesses the AENS application 140 to communicate with the AENS server 118, in particular, to enroll in the account event notification service and/or select certain account events to generate notifications.

The client system 130 may also be configured to communicate with the cardholder mobile device 102 and/or the cardholder computer system 104 associated with the cardholder 116. The cardholder mobile device 102 and/or cardholder computer system 104 may be configured to execute for presentation an issuer account event notification application 142. In some embodiments, the issuer account event notification application 142 may be stored in a cloud-based interface, which may include cloud storage capability as well as any cloud-based API that facilitates communication between the client system 130 and the AENS server 118 and/or between the cardholder mobile device 102 or cardholder computer system 104 and the AENS server 118. The AENS application 140 stores a user profile associated with the user, for example, in the cardholder account information database 122. The user profile includes cardholder contact and payment account data for the cardholder 116. Additionally, the user profile may be viewed, accessed, and/or updated by the cardholder mobile device 102 and/or the cardholder computer system 104. The cardholder 116 accesses the issuer account event notification application 142 to communicate with the AENS server 118, in particular, to enroll in the account event notification service and/or select certain account events to generate notifications.

The client system 130 may include, for example, any computing device, mobile or otherwise, that is capable of communicating with the transaction processor 120 and/or with the AENS server 118. In the example embodiment, the client system 130 is associated with the issuer 110. The AENS server 118 is configured to access the client system 130 through, for example, a cloud-based interface. The AENS server 118 is configured to communicate with client system 130 to receive, for example, user profile data (e.g., cardholder contact and payment account data for the cardholder 116, account event prompts, etc.). Additionally or alternatively, at least one of the cardholder mobile device 102 and/or the cardholder computer system 104 may access the client system 130 directly to transmit, for example user profile data. Although only one client system 130 is shown in FIG. 1 for clarity, it is understood that the AENS server 118 may be coupled in communication with any number of client systems 130.

In the example embodiment, the AENS server 118 receives user profile data from the cardholder 116 via one or more of the cardholder mobile device 102 and/or the cardholder computer system 104. The user profile data relates to a cardholder's contact information, account information, and/or account event notification data including selected account event prompts. The user profile data is stored by the AENS server 118 in the cardholder account information database 122. In addition, the AENS server 118 receives the cardholder's real-time transaction data from, for example, the interchange network 112. For a given transaction, the AENS server 118 identifies any cardholder selected account event prompt entries for the cardholder's account from the user profile data. If there are no cardholder selected account event prompt entries stored for the cardholder's account, then no further transaction processing is performed by the AENS server 118 and the transaction is processed business-as-usual (BAU) by the interchange network 112. If the cardholder's account has cardholder selected account event prompt entries, the AENS server 118 attempts to match the type of transaction to the cardholder selected account event prompt entries the cardholder 116 set up in advance. Based on the matching process, the AENS server 118 transmits a notification of the transaction and its type to the cardholder 116.

FIG. 2 is a simplified block diagram of an exemplary payment card network system 100 including the AENS server 118 in accordance with one embodiment of the present disclosure. The payment card network system 100 may be utilized by consumers and merchants as part of a process of performing a transaction concurrent with delivery of goods or services as described herein via the interchange network 112. In addition, the payment card network system 100 is a transaction card account system including the cardholder mobile device 102 and the cardholder computer system 104, which the cardholder 116 may use either to conduct electronic transactions and/or record payments for electronic transactions related to purchase of a merchant's goods or services. It should be understood that the various components shown in FIG. 2 may be a subset of a larger system that could be used, for example, to register or enroll the cardholder 116 in an account event notification service. It should also be understood that, in some embodiments, cardholders, merchants, issuers, and/or acquirers may participate in the cardholder enrollment or registration process (e.g., via an account event notification service website or webpage hosted by an AENS server computer system) before account event notification processing in accordance with embodiments described herein may occur.

The payment card network system 100 enables payment-by-card transactions in which merchants 106, acquirers 108, and/or card issuers 110 do not need to have a one-to-one relationship. Although parts of the payment card network system 100 are presented in one arrangement, other embodiments may include the same or different parts arranged otherwise, depending, for example, on authorization processes for purchase transactions, communication between computing devices, etc.

In the example embodiment, the payment card network system 100 generally includes the cardholder mobile device 102, the cardholder computer system 104, merchants 106, acquirers 108, issuers 110, and the interchange network 112 coupled in communication via a communications network 114. The network 114 includes, for example and without limitation, one or more of a local area network (LAN), a wide area network (WAN) (e.g., the Internet, etc.), a mobile network, a virtual network, and/or any other suitable public and/or private network capable of facilitating communication among the cardholder mobile device 102, the cardholder computer system 104, the merchants 106, the acquirers 108, the issuers 110, and/or the interchange network 112. In some embodiments, the network 114 may include more than one type of network, such as a private payment transaction network provided by the interchange network 112 to the acquirers 108 and the issuers 110 and, separately, the public Internet, which may facilitate communication between the cardholder computer system 104, the interchange network 112, the acquirers 108, and one or more cardholder mobile devices 102, etc.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique primary account number (PAN) associated with an account holder using a payment card issued by an issuer, purchase data representing a purchase made by the cardholder, including a type of merchant, amount of purchase, date of purchase, and other data, which may be transmitted between any parties of the payment card network system 100.

In a typical transaction card system, a financial institution called the “issuer” issues a transaction card, such as a credit card, to a consumer such as the cardholder 116, who uses the transaction card to tender payment for a purchase from the merchant 106. The cardholder 116 may input information from a transaction card into the cardholder mobile device 102 and/or cardholder computer system 104 and store the information as digital wallet data (broadly, payment credentials). The merchant 106 is typically associated with products, for example, and without limitation, goods and/or services, that are offered for sale and are sold to the cardholder 116. The merchant 106 includes, for example, a physical location and/or a virtual location such as an Internet- based store-front.

To accept payment from the cardholder 116, the merchant 106 must normally establish an account with a financial institution that is part of the payment card network system 100. This financial institution is usually called the “merchant bank,” the “acquiring bank,” or the acquirer 108. When the cardholder 116 submits payment for a purchase with the cardholder mobile device 102 and/or the cardholder computer system 104 using the digital wallet data, the merchant 106 requests authorization from the acquirer 108 for the purchase. The request may be performed over a telephone but is usually performed using a point-of-sale terminal that reads the cardholder's account information from a magnetic stripe, a chip, embossed characters on the transaction card, or digital wallet data and communicates electronically with the transaction processing computers of the acquirer 108. Alternatively, the acquirer 108 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 112, computers of the acquirer 108 or merchant processor will communicate with computers of the issuer 110 to determine whether the cardholder's account is in good standing and whether the purchase is covered by the cardholder's available credit line. Based on these determinations, the request for authorization will be declined or accepted. If the request is accepted, an authorization code is issued to the merchant 106.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 106 to charge, or “capture,” a transaction until the purchased goods are shipped or the purchased services are delivered. However, with respect to at least some debit card transactions, a charge may be posted at the time of the transaction. When the merchant 106 delivers the purchased products, the merchant 106 captures the transaction, for example, by appropriate data entry procedures on a point-of-sale terminal. This may include bundling of approved transactions daily for standard retail purchases. If the cardholder 116 cancels a transaction before it is captured, a “void” is generated. If the cardholder 116 returns goods after the transaction has been captured, a “credit” is generated. In some instances, if the cardholder 22 did not authorize the transaction, such as a previously cancelled recurring payment or a card-not-present account-on-file transaction, a “chargeback” is generated. The interchange network 112 and/or the issuer 110 stores the transaction card information, such as, and without limitation, a type of merchant, a merchant identifier, a location where the transaction was completed, an amount of purchase, and a date and time of the transaction, in a transaction database 134.

After a purchase has been made, a clearing process occurs to transfer additional transaction data related to the purchase among the parties to the transaction, such as the acquirer 108, the issuer 110, and the interchange network 112. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer 110, the cardholder's account is decreased. Normally, a charge is posted immediately to the cardholder's account. The interchange network 112 transmits the approval to the acquirer 108 for distribution of goods/services or information, or cash in the case of an automated teller machine (ATM).

After a transaction is authorized and cleared, the transaction is settled among the merchant 106, the acquirer 108, and the issuer 110. Settlement refers to the transfer of financial data or funds among the merchant's account, the acquirer 108, and the issuer 110 related to the transaction. Usually, transactions are captured and accumulated into a “batch,” which is settled as a group. More specifically, a transaction is typically settled between the issuer 110 and the interchange network 112, and then between the interchange network 112 and the acquirer 108, and then between the acquirer 108 and the merchant 106. It should be appreciated that more or less information related to transactions, as part of either authorization, clearing, and/or settling, may be included in the transaction data and stored within the transaction database 134, at the merchant 106, the acquirer 108, the payment network 112, and/or the issuer 110. Further, transaction data, unrelated to a particular payment account, may be collected by a variety of techniques, and similarly stored within the transaction database 134.

In some embodiments, cardholders 116 involved in the transactions described herein may be prompted to agree to legal terms associated with their payment accounts, for example, during enrollment in such payment accounts, etc. As such, the cardholder 116 may voluntarily agree to allow the merchants 106, the issuers 110, the interchange network 112, etc., to utilize data collected during enrollment and/or collected relating to processing the transactions, subsequently for one or more of the purposes described herein.

As shown in FIG. 2, the interchange network 112 includes the AENS server 118, which is, for example, and without limitation, a server, a network of multiple computing devices, a virtual computing device, or the like. In addition, in some embodiments, the payment card network system 100 may also include one or more client sub-systems 130 (also referred to as client systems) coupled in communication to the AENS server 118. The client systems 130 are computers including, for example, a web browser and a memory device, such that the AENS server 118 is accessible to the client systems 130 using, for example, the Internet. The client systems 130 are interconnected to the Internet through one or more interfaces including a network, such as a local area network (LAN) or a wide area network (WAN), dial-in-connections, cable modems, and special high-speed ISDN lines. The client systems 130 can be any device capable of interconnecting to the Internet including, for example, a web-based smartphone, a personal digital assistant (PDA), or any other web-based connectable equipment.

As described above, the payment card network system 100 includes one or more cardholder computer systems 104 that are connected to the AENS server 118, and in some embodiments, may be connected to the client systems 130. The cardholder computer systems 104 are interconnected to the Internet through one or more interfaces including a network, such as a local area network (LAN) or a wide area network (WAN), dial-in-connections, cable modems, wireless modems, and special high-speed ISDN lines. The cardholder computer systems 104 can be any computing device capable of interconnecting to the Internet and including an input device capable of reading or storing information from a user's financial transaction card, including the digital wallet data 306.

Furthermore, as described above, the payment card network system 100 includes at least one cardholder mobile device 102 (e.g., a smartphone or other computing device used by the consumer to complete transactions), which is configured to communicate with the AENS server 118. In one embodiment, the cardholder mobile device 102 is associated with or controlled by a consumer making a purchase using a transaction card account and the payment card network system 100. The cardholder mobile device 102 may be interconnected to the Internet through one or more interfaces including a network, such as a LAN or a WAN, dial-in-connections, cable modems, wireless connections, and special high-speed ISDN lines. The cardholder mobile device 102 can be any computing device capable of interconnecting to the Internet including a mobile web-based device, smartphone, PDA, or other mobile web-based connectable equipment. In the example embodiment, the cardholder mobile device 102 is configured to communicate with the AENS server 118 to transmit, for example, and without limitation, the cardholder's account access credentials, contact information, and/or account event notification data to the AENS server 118. The cardholder mobile device 102 is configured to communicate with the AENS server 118 using various outputs including, for example, radio frequency communication, near field communication (NFC), network-based communication, and the like.

The AENS server 118 is connected to the transaction database 134. In one embodiment, the transaction database 134 is stored on the AENS server 118 and can be accessed by users at one of the client systems 130 by logging onto the AENS server 118 through one of the client systems 130. In an alternative embodiment, the transaction database 134 is stored remotely from the AENS server 118 and may be non-centralized. The transaction database 134 may store transaction data generated as part of financial transaction activities conducted over the bankcard network, including data relating to merchants, account holders or consumers, and purchases. The transaction database 134 may also store account data including at least one of a user name, a user address, an account number, and other account identifiers. The transaction database 134 may also store merchant data including a merchant identifier that identifies each merchant registered to use the payment account card network, and instructions for settling transactions including merchant bank account information. The transaction database 134 may also store primary account numbers (PANs) or bank account numbers for various parties including merchants and consumers, along with payment verification identifiers and other data necessary to implement the system and processes described herein.

As described herein, the AENS server 118 is configured to receive from the cardholder 116 various account event notification data and analyze various data associated with the payment card transactions based, in part, on the account event notification data. In addition, the AENS server 118 is configured to provide various information, such as an account event notification to one or more parties involved in the payment card transaction, such as the cardholder 116. Specifically, the AENS server 118 is a specially programmed computer system that enables the interchange network 112 to implement an automated process for cardholder registration and to analyze real-time transaction data associated with the cardholder account to transmit notifications to the cardholder. The cardholder may register with the interchange network 112 to be notified of selected account event prompts. The AENS server 118 may analyze the real-time transaction data, based in part on the account event notification data, to facilitate keeping a cardholder that has opted to take advantage of the account event notification service informed about certain activity against his or her account.

In the example embodiment, the following associations may be made: one of the client systems 130 may be associated with an acquirer, a user, or a consumer; another one of the client systems 130 may be associated with an issuer; the cardholder mobile device 102 and the cardholder computer system 104 may be associated with a consumer; and the AENS server 118 may be associated with a payment network or interchange network. While only one merchant 106, acquirer 108, interchange network 112, and issuer 110 are shown in FIG. 2 (for ease of reference), it should be appreciated that a variety of other embodiments may include multiple ones of these parts in various combinations.

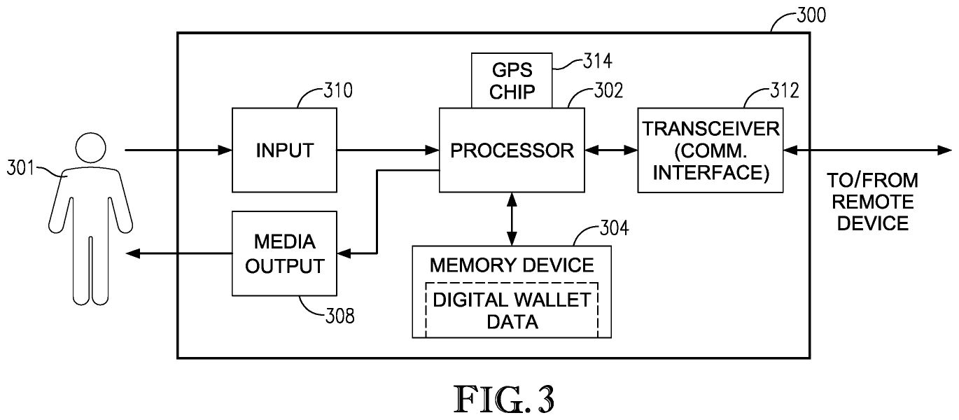

FIG. 3 is an example configuration of a user system 300 operated by a user 301, such as the cardholder 116 (shown in FIG. 2). In some embodiments, the user system 300 is a cardholder mobile device 102 (shown in FIG. 1), a cardholder computer system 104 (shown in FIG. 1), and/or a client system 130 (shown in FIG. 1).

In the example embodiment, the user system 300 includes one or more processors 302 for executing instructions. In some embodiments, executable instructions are stored in a memory device 304. The processor 302 may include one or more processing units arranged, for example, in a multi-core configuration. The memory device 304 is any device allowing information such as digital wallet data (optional), executable instructions, and/or written works to be stored and retrieved. The memory device 304 includes one or more computer readable media.

In one example embodiment, the processor 302 may be implemented as one or more cryptographic processors. A cryptographic processor may include, for example, dedicated circuitry and hardware such as one or more cryptographic arithmetic logic units (not shown) that are optimized to perform computational intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

A location of the user system 300 can be obtained through conventional methods, such as a location service (e.g., global positioning system (GPS) service) in the user system 300, “ping” data that includes geotemporal data, from cell location register information held by a telecommunications provider to which the user system 300 is connected, and the like. For example, in one suitable embodiment, a GPS chip 314 can be part of or separate from the processor 302 to enable the location of the user system 300 to be determined.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In one example embodiment, the media output component 308 includes an integrated display, which can include, for example, and without limitation, a liquid crystal display (LCD), an organic light emitting diode (OLED) display, or an “electronic ink” display. In some embodiments, the integrated display may optionally include a touch controller for support of touch capability. In such embodiments, a cardholder mobile device 102 may detect a person's presence by detecting that the person has touched the integrated display on the cardholder mobile device 102.

In some embodiments, the user system 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310, as described above. The user system 300 may also include a transceiver 312 (broadly, a communication interface), which is communicatively connectable to a remote device such as the client system 130 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and/or the AENS application 140 (shown in FIG. 1). Web browsers enable users, such as the cardholder 116, to display and interact with media and other information typically embedded on a web page or a website from the AENS server 118. The AENS application 140 and/or the issuer account event notification application 142 allow the cardholder 116 to interact with the AENS server 118 to register selected account event prompt entries for generating notifications.

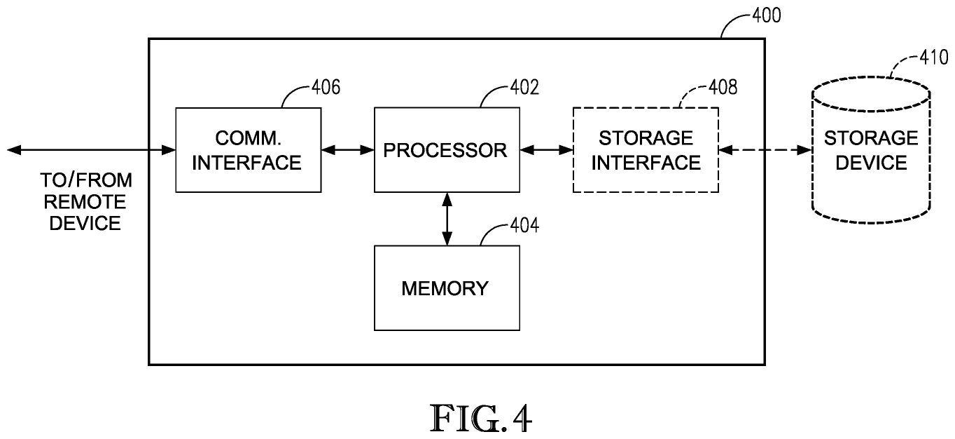

FIG. 4 is an example configuration of a server system 400, such as the AENS server 118 (shown in FIG. 1). In some embodiments, the server system 400 is substantially like the AENS server 118. In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

In one example embodiment, the processor 402 may be implemented as one or more cryptographic processors. A cryptographic processor may include, for example, dedicated circuitry and hardware such as one or more cryptographic arithmetic logic units (not shown) that are optimized to perform computational intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

The processor 402 is operatively coupled to a communication interface 406 such that the server system 400 can communicate with a remote device such as a user system 300 or another server system 400. For example, the communication interface 406 may receive communications from the cardholder mobile device 102 and/or the cardholder computer system 104 via the Internet, as illustrated in FIG. 1.

The processor 402 is operatively coupled to the storage device 410. The storage device 410 is any computer-operated hardware suitable for storing and/or retrieving data. In some embodiments, the storage device 410 is integrated in the server system 400 and is like the cardholder account information database 122 (shown in FIG. 1). In other embodiments, the storage device 410 is external to the server system 400 and is like the transaction database 134 (shown in FIG. 2). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Account Registration

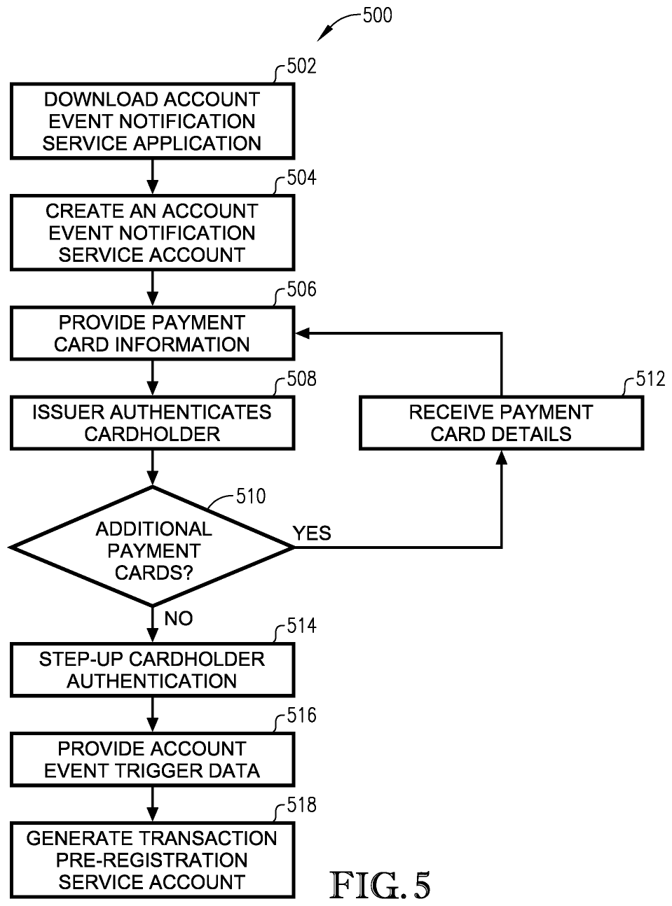

FIG. 5 is a flowchart illustrating an exemplary computer-implemented method 500 for registering a cardholder for an account event notification service, in accordance with one embodiment of the present disclosure. The operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-4. In one embodiment, the method 500 may be implemented by the payment card network system 100 (shown in FIG. 1). In the exemplary embodiment, the method 500 relates to the receiving of cardholder registration information from the cardholder mobile device 102 (shown in FIG. 1) upon registration for the account event notification service. While operations within the method 500 are described below regarding the cardholder mobile device 102, the method 500 may be implemented on the cardholder computer system 104 as well as other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The cardholder 116 must be registered for the account event notification service to receive notifications associated with a transaction corresponding to one or more of the cardholder's accounts. Referring to operation 502, in the example embodiment, the cardholder 116 downloads an event notification application, such as, for example, and without limitation, the AENS application 140 (shown in FIG. 1) or the issuer account event notification application 142. The choice of event notification application may depend, for example, on whether the cardholder's payment card issuer provides the service or whether the cardholder chooses to register directly through the interchange network 112. The cardholder 116 may connect to the AENS server 118, which may instruct the cardholder 116 to download the AENS application 140 or the issuer account event notification application 142 to the cardholder mobile device 102 for direct communication with the AENS server 118 via the interchange network 112, e.g., without use of a web browser. When the cardholder 116 uses the AENS application 140 or the issuer account event notification application 142, a direct link is established via a wireless connection, for example, via a Wi-Fi connection to the network 114. In an alternative embodiment, the cardholder may connect to the AENS server 118, for example, via a webservice providing account event notification registration.

In the exemplary embodiment, the cardholder mobile device 102, such as a web-based smartphone, is configured to execute for presentation the AENS application 140 or the issuer account event notification application 142. In some embodiments, the AENS application 140 or issuer account event notification application 142 may be stored in a cloud-based interface, which may include cloud storage capability as well as any cloud-based API that facilitates communication between the cardholder mobile device 102 and AENS server 118. The AENS application 140 and the issuer account event notification application 142 facilitate transmitting and receiving data between the cardholder mobile device 102 and AENS server 118 for registering (or enrolling) the cardholder 116 and selecting account event prompts for generating notifications.

At operation 504, the cardholder 116 is presented an option to create an account event notification service (AENS) account. For example, the cardholder 116 registers or enrolls for the account event notification service via the AENS application 140, the issuer account event notification application 142, or via a suitable webpage of the AENS server 118 using, for example, the cardholder mobile device 102 or the cardholder computer system 104. It should be understood that the cardholder 116 may enroll or register with the account event notification service in any of several ways, including utilizing the cardholder computer system 104 to access the AENS server 118 via the Internet and providing the requisite information. During cardholder enrollment, the cardholder 116 may provide enrollment data including basic information about himself or herself (e.g., name, address, phone number, etc.) and, in some embodiments, provide information regarding the consumer's mobile devices (for example, by providing a SIM identifier and/or a mobile telephone number and/or other mobile device identifier). In addition, the cardholder 116 may provide information and/or preferences concerning one or more family members, such as a spouse and/or children to form a “Household” AENS account. It is noted that the AENS account can be linked to other Mastercard services if the cardholder 116 is already signed up for other unrelated services. In some embodiments, the information obtained from the cardholder 116 during the enrollment process includes product and/or service preferences, requirements data, and/or other information.

At operation 506, the cardholder 116 may also provide information concerning his or her payment card, e.g., bank credit card primary account number, debit card primary account number, loyalty card primary account number, and/or gift card primary account number issued to or held by him or her. At operation 508, the AENS server 118 authenticates the cardholder 116. For example, and without limitation, the cardholder 116 may be asked to input a string of characters indicating a code printed on the signature panel of the cardholder's payment card. The signature panel code may be, for example, a card verification code (CVC) value. The values entered by the cardholder 116 may be used by the AENS server 118 to authenticate the cardholder 116 prior to setting up the AENS account and associating the cardholder 116 and the cardholder's payment card with the account. For example, the AENS server 118 compares the entered values to the values associated with the payment card stored in a database (e.g., the database 134 shown in FIG. 1). If the entered values match the stored values, the cardholder 116 is authenticated.

Alternatively, the AENS server 118 may authenticate the cardholder 116 via a one-time code sent to the cardholder 116 via, for example, Short Message Service (SMS), e-mail, through a call center communication, and the like. Optionally, the method 500 may include an additional operation for authenticating the cardholder 116 offline. For example, and without limitation, the AENS server 118 may provide an offline PIN to the cardholder 116 via mail.

At operation 510, the AENS server 118 asks the cardholder 116 whether the cardholder has additional payment cards he or she wishes to associate with the cardholder's AENS account. If the cardholder has additional payment cards to enter, at operation 512, the AENS server 118 receives the payment card details from the cardholder 116 and returns to operation 506. If the cardholder does not have any additional payment cards to enter, the method continues to operation 514.

At operation 514, the AENS server 118 requests that the cardholder 116 set up a step-up authentication method, i.e., two-factor authentication. The additional authentication measures may be taken before the account event prompts may be entered into the account event notification service by the cardholder 116. For example, and without limitation, in one embodiment, the cardholder 116 is requested to establish account access credentials, e.g., to select a username and password or PIN (personal identification number) to be used for security purposes, and/or for use by the cardholder 116 to login and change one or more preference and/or notification settings, for example. In addition to the password or PIN, the cardholder may be requested to set up a second authentication factor, including, for example, and without limitation, providing a biometric sample that is to be associated with the other registration information provided.

Biometric samples include, without limitation, a fingerprint image, a voice recording, a retinal image, facial recognition, palm print image, iris recognition, and the like. The biometric sample is unique to the cardholder 116 and difficult to duplicate and/or forge by an unauthorized user. The biometric sample may be stored and associated with a biometric identifier, for example, by the AENS server 118 (e.g., in the database 134, etc.). Additionally, the biometric identifier may be associated with the stored registration information and facilitates secure authorization of requested notification data input by the cardholder 116. A biometric input device in communication with the cardholder mobile device 102 may be used for the cardholder 116 to enter the biometric sample. For example, the cardholder mobile device 102 may include an integral fingerprint or palm reader/scanner, retinal or iris reader/scanner, and/or voice reader/recorder.

In other suitable embodiments, the second factor may include, for example, and without limitation, SMS two-factor authentication (where a one-time use short code is sent to the cardholder's mobile device via SMS), Time-Based One Time Password (TOTP) authentication (where an authenticator application provides a short code as a second factor), push-based two-factor authentication (where a prompt is sent to the cardholder's mobile device), or any other two-factor authentication method that enables the method 500 to operate as described herein.

At operation 516, the AENS server 118 requests that the cardholder 116 setup account event prompt data (or account event prompt entries) that may be used by the account event notification service to generate account event notifications for the cardholder. For example, and without limitation, the cardholder 116 may select to receive notifications related to credits, reversals, chargebacks, and/or suspected fraud associated with one or more of the cardholder's accounts. In one embodiment, the cardholder 116 may be presented with a list of his or her registered accounts. For each registered account, the cardholder 116 may be presented with an option to select to receive one or more event notifications, for example, by selecting or clicking a checkbox. The selections may then be saved, for example, as part of the account event notification data of the account event notification service account for the cardholder 116 in the database 134.

At operation 518, the AENS server 118 generates the AENS account for the cardholder 116, associating the cardholder's one or more payment cards with the account along with the cardholder's account access credentials and account event notification data, and stores the AENS account in a database, e.g., the database 134.

### Generating Account Event Notification

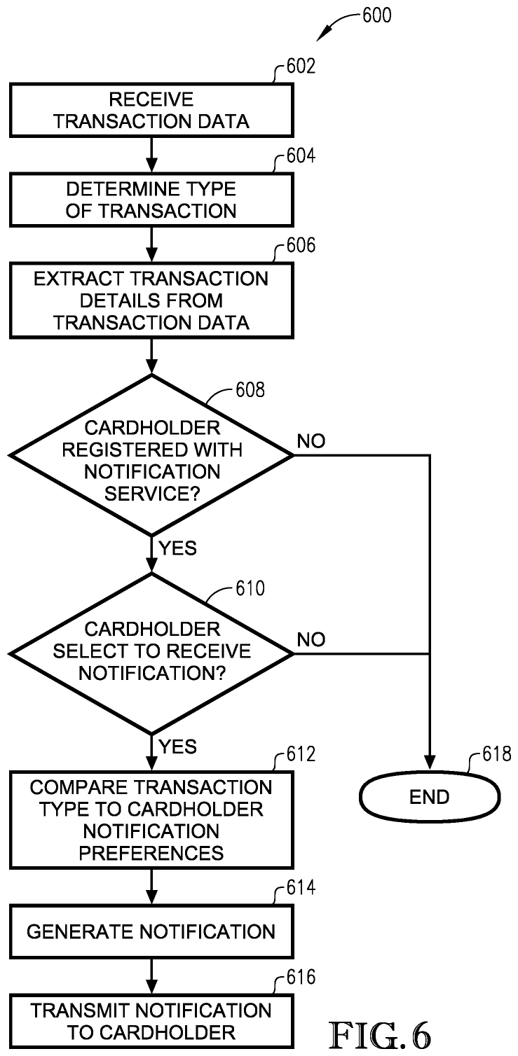

FIG. 6 is a flowchart illustrating a computer-implemented method 600 for generating an account event notification using an account event notification service, in accordance with one embodiment of the present disclosure. The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-4. In one embodiment, the method 600 may be implemented by the payment card network system 100 (shown in FIG. 1). In the exemplary embodiment, the method 600 relates to receiving account event notification data from the cardholder 116 (shown in FIG. 1) and transaction data from the interchange network 112 (shown in FIG. 1). While operations within the method 600 are described below regarding the cardholder mobile device 102, the method 600 may be implemented on the cardholder computer system 104 as well as other such devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 602, the AENS server 118 may receive an electronic transaction message including cardholder transaction data from the interchange network 112. As used herein, the term “electronic transaction message” includes specially-formatted data describing events, requests, and replies. In general, electronic messaging includes the creation, storage, exchange, and management of text, images, voice, telex, fax, e-mail, paging, and Electronic Data Interchange (EDI) over a communications network, such as the network 114.

In the exemplary embodiment, the cardholder transaction data may correspond to a payment card account associated with the cardholder's AENS account. For example, and without limitation, the cardholder transaction data may be included in an electronic transaction message such as may be received from an issuer or a merchant point of sale device (e.g., directly or as transmitted via one or more intermediate entities). Typical electronic transaction messages may be formatted pursuant to one or more standards, such as the International Organization of Standardization ISO 8583 standard, and may include a plurality of data elements, where each data element may be configured to store payment and transaction data as set forth in the associated standards. The data elements may include, for example, a data element configured to store a PAN, a data element configured to store a transaction type, a data element configured to store a transaction amount, a data element configured to store a transaction time, etc. The electronic transaction messages may also include a message type indicator, which may be indicative of a type of the electronic transaction message, such as an authorization request, authorization response, etc. In some instances, an electronic transaction message may also include a bitmap, which may indicate the data elements included in the electronic transaction message and the data stored therein.

At operation 604, the AENS server 118 may determine the type of transaction indicated by the electronic transaction message. In the exemplary embodiment, the electronic transaction message may include several transaction types, including a credit transaction, a reversal transaction, a chargeback transaction, and/or a message declining a transaction due to suspected fraud. An electronic credit transaction message may include, for example, a financial transaction request message (e.g., a message type indicator (MTI) 0200 message) having the data element 3 (DE 3) processing code 20 for refund/return. If a transaction is terminated, for example, after a pre-authorization, the electronic transaction message may be a reversal message (e.g., an MTI 0400 message). Furthermore, an electronic first chargeback transaction message may include, for example, an MTI 1442 message having a function code of 450 for the full amount of the transaction, or an MTI 1442 message having a function code of 453 for a partial amount of the transaction. It is noted that each of the electronic transaction messages may include a transaction amount, as is described herein.

In some instances, the electronic transaction message may be an MTI 0110 authorization request response message indicating that the transaction is declined due to suspected fraud. The MTI 0110 message may include, for example, one or the following data element 39 (DE 39) response codes.

| DE 39 | Description | Action |
|---|---|---|
| 04 | Capture card | Capture |
| 05 | Do not honor | Decline |
| 41 | Lost card | Capture |
| 43 | Stolen card | Capture |
| 57 | Transaction not permitted | Decline |
| | to issuer/cardholder | |
| 62 | Restricted card | Decline |
| 63 | Security violation | Decline |

In addition, MTI 0110 message may include a fraud score stored in a data element of the MTI 0110 message. In one particular example, the MTI 0110 message may contain a data element 48 (DE 48) that includes a fraud score. Most preferably, the fraud score may be indicated in DE 48, sub element 75, and sub field 1, and indicating a value equal to or greater than a threshold value, such as 750. Alternatively, accordingly to certain aspects of the disclosure, the fraud score may be contained in any data element of the MTI 0110 message and may have any value than enables the AENS server 118 to function as described herein.

In the exemplary embodiment, at operation 606, the AENS server 118 may extract transaction details from the electronic transaction message, and more particularly, from the transaction data received, for example, from the merchant 106, acquirer 108, issuer 110, etc. Specifically, the AENS server 118 may extract a copy of the PAN from the transaction details of the electronic transaction message and temporarily store it in memory, such as memory 404 (shown in FIG. 4).

At operation 608, the AENS server 118 may determine whether the cardholder 116 is registered for the account event notification service. Specifically, the AENS server 118 may retrieve the AENS accounts from the database 134 and attempt to match the extracted PAN to a payment card associated with a cardholder's respective AENS account. The AENS server 118 maintains a list of PANs associated with the cardholders 116 who are registered with the account event notification service. The PANs are stored in the AENS account for the cardholder 116 on the database 134.

If there is no match, the process ends at operation 618. If there is a match based on the comparison of the extracted PAN to the list of PANs associated with the AENS accounts, at operation 610, the AENS server 118 may determine whether the cardholder selected to receive a notification message corresponding to selected types of transactions. As described herein, the cardholder 116 may select to receive one or more notification messages of transactions associated with an account including, a credit transaction, a reversal transaction, a chargeback transaction, and/or a declined transaction due to suspected fraud. In one suitable example, the AENS server 118 analyzes the account event notification data stored in the AENS account for the cardholder 116 to confirm whether the account event notification data indicates that the cardholder 116 selected to receive a notification for one or more account transaction types (e.g., one or more of a credit transaction, a reversal transaction, a chargeback transaction, and/or a declined transaction due to suspected fraud). If the cardholder 116 did not select to receive a notification message, the process ends at operation 618.

At operation 612, if the cardholder 116 selected to receive a notification message corresponding to selected types of transactions, the AENS server 118 may compare the transaction type indicated by the electronic transaction message to the cardholder's selected notification preferences (i.e., for which type of transactions to receive notifications). If there is a match, at operation 614, the AENS server 118 may generate a corresponding notification message of the transaction. In the exemplary embodiment, the notification message may be generated in real time or near real time. As used herein, the term “real time” includes the time of occurrence of the associated events, the time to process data, and/or the time of a system response to the events and the environment. In the embodiments described herein, these activities and events occur substantially instantaneously.

In the exemplary embodiment, the transaction notification message may contain information specific to the type of transaction. The electronic transaction message may contain various transaction information, including, without limitation, a name of the merchant 106, a location of the merchant 106, a date of the transaction, and an amount of the transaction. This information may be used by the AENS server 118 to generate the notification message. For example, in one embodiment, if the transaction type is a credit transaction, the AENS server 118 may generate a notification indicating the date of the transaction, the merchant name, and the amount of the credit. In another embodiment, if the transaction is a reversal, for example, if the transaction was terminated, the notification message may indicate the date of the reversal, the merchant name, and the amount of the reversal. If the transaction is a chargeback, the notification message may indicate the amount of the chargeback and the name of the merchant the chargeback is being process against. In instances where the transaction was declined, if the electronic transaction message indicated that the transaction was declined due to suspected fraud as described above, the notification message may only include information that the transaction was declined due to suspected fraud and a message suggesting that the cardholder 116 should contact the payment card issuer 110.

The notification messages are generated in a format that can be received by and presented to the cardholder 116, for example, on the cardholder mobile device 102 and/or the cardholder computer system 104. The notification message sent to a mobile device, such as the cardholder mobile device 102, may be in a particular format and may conform to requirements defined by a mobile network operator. For example, and without limitation, a mobile network operator may specify that an SMS message has limitations on a number of characters and/or a pre-determined memory size (e.g., bits, bytes, etc.).

At operation 616, the AENS server 118 may transmit the notification message to the cardholder 116. In particular, the AENS server 118 may transmit the notification message to the cardholder mobile device 102 (e.g., identified by the mobile device identifier described herein) via a preferred method of delivery selected by the cardholder 116 and stored as part of the account event notification data stored in the AENS account for the cardholder 116. In some embodiments, the preferred method of delivery may include, for example, and without limitation, the form of a push notification, an interactive voice response (IVR), an instant message (IM), an SMS message, a voicemail message, an email message, a web-based application message (e.g., via a digital wallet payment application at the cardholder mobile device 102, etc.), or any other suitable message form transmitted, in this example, to the cardholder mobile device 102 and/or cardholder computer system 104. It should be understood that other notification message content and/or a different delivery methods may be defined by the cardholder in the account event notification data stored in the AENS account. Further, it should be understood that the AENS server 118, for example, may provide the cardholder 116 additional modes of notification messages, such as audio notifications, that enable the method 600 to function as described herein.

Any actions, functions, operations, and the like recited herein may be performed in the order shown in the figures and/or described above or may be performed in a different order. Furthermore, some operations may be performed concurrently as opposed to sequentially. Although the methods are described above, for the purpose of illustration, as being executed by an example system and/or example physical elements, it will be understood that the performance of any one or more of such actions may be differently distributed without departing from the spirit of the present disclosure.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, Wi-Fi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the disclosure has been described with reference to the one or more embodiments illustrated in the figures, it is understood that equivalents may be employed, and substitutions made herein without departing from the scope of the disclosure as recited in the claims.

Having thus described one or more embodiments of the disclosure, what is claimed as new and desired to be protected by Letters Patent includes the following:

What is claimed is:

1. A computer-implemented method for notifying a cardholder of an account event using an account event notification service, said method comprising the operations of:
receiving an electronic transaction message including transaction data from an interchange network, the transaction message including a type of transaction associated with a primary account number of the cardholder;
determining the type of transaction from the electronic transaction message;
extracting transaction details from the transaction data;
determining whether the cardholder is registered for the account event notification service;
generating a notification message if, based on the determination, the cardholder is registered for the account event notification service, the notification message including the type of transaction; and
transmitting the notification message to the cardholder.

2. The computer-implemented method in accordance with claim 1, wherein the type of transaction includes one or more of the following: a credit transaction, a reversal transaction, a chargeback transaction, and a declined transaction due to suspected fraud.

3. The computer-implemented method in accordance with claim 1, further comprising:
determining whether the cardholder selected to receive the notification message corresponding to the type of transaction.

4. The computer-implemented method in accordance with claim 3, wherein said operation of determining whether the cardholder selected to receive the notification message includes the operations of:
retrieving the account event notification service account for the cardholder from a database; and
analyzing account event notification data stored in the account event notification service account to determine whether the account event notification data indicates that the cardholder selected to receive the notification message corresponding to the type of transaction.

5. The computer-implemented method in accordance with claim 4, further comprising:
comparing the type of transaction to the account event notification data stored in the account event notification service account.

6. The computer-implemented method in accordance with claim 1, wherein said operation of extracting transaction details from the transaction data includes the operation of extracting the primary account number of the cardholder from the transaction data.

7. The computer-implemented method in accordance with claim 6, wherein said operation of determining whether the cardholder is registered for the account event notification service includes the operation of comparing the extracted primary account number to a list of primary account numbers associated with cardholders who are registered with the account event notification service.

8. The computer-implemented method in accordance with claim 1, wherein said operation of generating the notification message includes the operation of formatting the notification message in a format that can be received by a cardholder mobile device.

9. The computer-implemented method in accordance with claim 8, wherein said operation of transmitting the notification message to the cardholder includes the operation of transmitting the notification message to the cardholder mobile device using a preferred method of delivery selected by the cardholder.

10. The computer-implemented method in accordance with claim 9, wherein the preferred method of delivery includes one or more of the following: a push notification, an interactive voice response, an instant message, a short message service message, a voicemail message, an email message, and a web-based application message.

11. The computer-implemented method in accordance with claim 1, wherein the electronic transaction message is a message type indicator (MTI) 0200 message including a data element 3 (DE 3) having a processing code 20, and wherein the notification message includes a date of a credit transaction corresponding to the electronic transaction message, a merchant name, and an amount of a credit to the primary account number.

12. The computer-implemented method in accordance with claim 1, wherein the electronic transaction message is a message type indicator (MTI) 0400 message, and wherein the notification message includes a date of a reversal transaction corresponding to the electronic transaction message, a merchant name, and an amount of a reversal to the primary account number.

13. The computer-implemented method in accordance with claim 1, wherein the electronic transaction message is a message type indicator (MTI) 1442 message including a function code including one of 450 or 453, and wherein the notification message includes a date of a chargeback transaction corresponding to the electronic transaction message, a merchant name, and an amount of a chargeback to the merchant named.

14. The computer-implemented method in accordance with claim 1, wherein the electronic transaction message is a message type indicator (MTI) 0110 message including a fraud equal to or greater than a threshold value and a data element 39 (DE 39) response code including at least one of the following codes: 04, 05, 41, 43, 57, 62, and 63.

15. The computer-implemented method in accordance with claim 1, further comprising generating an account event notification service account for the cardholder, comprising:
presenting to the cardholder an option to create the account event notification service account;
receiving from the cardholder enrollment data including a primary account number associated with a payment account of the cardholder and account access credentials;
storing the account access credentials; and
authenticating the cardholder.

16. A system for notifying a cardholder of an account event, said system comprising:
a cardholder account information database;
a transaction database; and
an account event notification service server comprising a processor programmed to:
receive an electronic transaction message including transaction data from said transaction database, the transaction message including a type of transaction associated with a primary account number of the cardholder,
determine the type of transaction from the electronic transaction message,
extract transaction details from the transaction data,
determine whether the cardholder has an account event notification service account stored on the cardholder account information database,
generate a notification message if, based on the determination, the cardholder has an account event notification service account, the notification message including the type of transaction, and
transmit the notification message to the cardholder.

17. The system in accordance with claim 16, wherein said processor is further programmed to:
determine whether the cardholder selected to receive the notification message corresponding to the type of transaction.

18. The system in accordance with claim 17, as part of determining whether the cardholder selected to receive the notification message, said processor being further programmed to:
retrieve the account event notification service account from the cardholder account information database; and
analyze account event notification data stored in the account event notification service account to determine whether the account event notification data indicates that the cardholder selected to receive the notification message corresponding to the type of transaction.

19. The system in accordance with claim 18, wherein said processor is further programmed to:
compare the type of transaction to the account event notification data stored in the account event notification service account.

20. The system in accordance with claim 16, as part of extracting the transaction details from the transaction data, said processor being further programmed to:
extract the primary account number of the cardholder from the transaction data, and as part of determining whether the cardholder has an account event notification service account, said processor being further programmed to:
compare the extracted primary account number to a list of primary account numbers associated with account event notification service accounts stored on said cardholder account information database.
